(19) United States
(12) Patent Application Publication
(10) Pub. No.: US 2008/0258385 A1
(43) Pub. Date: Oct. 23, 2008

(54) TEXTURED CHIP AND CHIP RESURFACING MACHINE

(75) Inventors: Arthur RAYMOND, North Las Vegas, NV (US); Ronald AINSWORTH, Las Vegas, NV (US)

Correspondence Address: Hershkovitz & Associates, LLC, 2845 Duke Street, Alexandria, VA, 22314, US

(73) Assignee: GAMING PARTNERS INTERNATIONAL USA, INC., Las Vegas, NV (US)

(21) Appl. No.: 12/101,898

(22) Filed: Apr. 11, 2008

Related U.S. Application Data
(60) Provisional application No. 60/907,649, filed on Apr. 12, 2007.

(51) Int. Cl. A63F 9/00; B29C 59/02

(52) U.S. Cl. 273/148 R; 428/67; 425/436 R; 264/293

(57) ABSTRACT

A chip, token or gaming piece having a textured pattern on either or both of its upper and lower planar surfaces and a machine for applying the textured pattern so as to reduce or prevent chips, tokens or gaming pieces from sticking together, are provided. The textured pattern can extend through to the peripheral edges of the chip, token or gaming piece to introduce air and break the surface tension on the planar surfaces. The machine can include an input collection hopper that delivers chips, tokens or gaming pieces individually to a receiver. At the receiver, a slide carriage can move each chip to a working position where dies can be pressed against the planar surfaces to imprint a pattern of indentations or grooves. After the textured pattern is applied, the chip, token or gaming piece can be removed from the working area and sent to an output hopper. A method of making the chip, token or gaming piece is also provided.

### CROSS-REFERENCE TO RELATED APPLICATIONS

The present application claims priority under 35 U.S.C. 119(e) of U.S. Provisional Patent Application No. 60/907,649, filed on Apr. 12, 2007, the disclosure of which is expressly incorporated by reference herein in its entirety.

### BACKGROUND OF THE INVENTION

1. Field of the Invention

The present invention relates to chips, tokens or gaming pieces. Chips, tokens or gaming pieces are used at casinos and other areas to represent different values. They are small enough to be manipulated easily by hand, stacked, moved about a table, and passed between individuals.

3. Discussion of Background Information

“Chips,” “tokens” or “gaming pieces” are used interchangeably herein and are defined as small, physical representations of certain values, such as a monetary value, that can be used in casinos or elsewhere. Currently in use, they are typically round and plastic with a minimal thickness, and are intended to be easily manipulated by a user's fingers and hands. The upper and lower chip surfaces are usually smooth and planar. When the planar surfaces of adjacent chips abut each other, the mutually contacting surfaces exhibit a tendency to adhere. Fluids, either gaseous (air) or liquid, that collect on the planar surfaces join the chips by adhesion and cohesion. Since there are no irregularities to break the fluid surface tension or to allow air to intercede, the adhesion is sufficient in some cases to join abutting chips. Consequently, chips tend to stick together when handled by a player, dealer, or other person desiring to stack or count chips. Chips that stick together are more difficult to handle and discriminate, and may be miscounted or misplaced. Separating chips is time consuming and can lead to fewer hands being dealt at the gaming table.

### SUMMARY OF THE INVENTION

The present invention overcomes the tendency of chips to stick together by providing texture on the planar surfaces of the chips. According to the present invention, chips can be made with a pattern extending into the upper and lower planar surfaces. Various patterns can be used. Most beneficially, the pattern can be formed by very small indentations, such as grooves, that can extend to the outer edge of the chip to break the surface tension and allow the introduction of air between the two surfaces.

The textured pattern can be formed by a rectangular or square grid of depressed lines, extending from edge to edge across the planar surfaces. Other patterns such as diamonds, hexagons or octagons can also be used. However, the textured patterns are not limited to these and any pattern can be used. In order to avoid a surface that is too rough, the area of the indentations, grooves, or depressed lines on the planar surfaces is preferably no more than about 25% of the total surface area of the planar surfaces. This area can be as small as about 2%. Preferably, this area is about of 5%. Preferably, the spacing of the indentations or grooves, their width and their depth, make the chip surface feel somewhat “velvety” rather than slick.

The textured pattern can be applied to existing chips. A machine capable of being brought to and installed at an established casino forms the texture on individual chips at a high rate of speed. The texture machine can include an inlet for a number of chips and a receiver supplied with chips individually from the inlet. The receiver can then be moved to a working position where the chip is subjected to heat and pressure to impress the pattern from a die or dies. The textured chip is then moved from the working area to an outlet hopper.

In one embodiment of the invention, the input is in the form of a vibratory bowl feeder.

Movement of the receiver from its loading position to its working position can be controlled by an air operated reciprocating feed cylinder.

In one or more embodiments of the present invention, in its working position, the receiver positions the chip between a moveable upper die and a stationary lower die, each die having a suitable pattern thereon. Each die can also include a cartridge heater, typically electric, to better enable the die to be pressed into the chip surfaces. A ram connected to a piston, driven by a pneumatic cylinder, can move the upper die.

After the ram and upper die are lifted, the now textured chip can be moved to an outlet hopper. In a particular embodiment, an air jet blows the chip from its working position to a guide tube leading into a suspended hopper.

Although other sources can be used, in a preferred embodiment, the principal machine components derive their power from compressed air. Suitable valves can direct the pressurized air in the proper sequence to the feed cylinder, the ram and the blower. The valves and other elements of the machine can be controlled from an electrical panel that establishes the duration of each movement as well as the temperature of the die heaters.

According to one aspect of the invention, a chip, token or gaming piece comprises a plastic body having at least one upper planar surface and at least one lower planar surface. At least one narrow peripheral edge surface can extend between the at least one upper planar surface and the at least one lower planar surfaces. At least one textured pattern can be formed on at least one of the at least one upper planar surface and the least one lower planar surface, the at least one textured pattern being defined by indentations that traverse at least one of the at least one upper planar surface and the at least one lower planar surface. The indentations can have a predetermined depth and are sufficient in number and depth to reduce or prevent one of the at least one upper planar surface and the at least one lower planar surface from sticking or adhering to another planar surface of another chip, token or gaming piece.

According to other aspects of the invention, the indentations on the chip, token or gaming piece can comprise grooves. The grooves can be one of continuous and discontinuous grooves. The indentations can extend to the at least one narrow peripheral edge surface. The chip, token or gaming piece can further comprise at least one embedded microchip. The at least one textured pattern can disrupt surface tension between one of the at least one upper planar surface or the at least one lower planar surface of a chip, token or gaming piece and another planar surface of another chip, token or gaming piece. The indentations can extend across one of the at least one upper planar surface and the at least one lower planar surface in one of a straight line, a curved line, and a combination of straight and curved segments. The indentations can cover an indentation area of about 25% of one of a total area of the at least one upper planar surface and a total area of the at least one lower planar surface. Preferably, the indentation area is less than about 25% of one of a total area of the at least one upper planar surface and a total area of the at least one lower planar surface. More preferably, the indentation area is from about 2% to about 15% of one of a total area of the at least one upper planar surface and a total area of the at least one lower planar surface. Most preferably, the indentation area is from about 2% to about 5% of one of a total area of the at least one upper planar surface and a total area of the at least one lower planar surface. The at least one textured pattern can comprise a grid formed by at least one of rectangles, squares, diamonds, hexagons, and other shapes formed by intersections of continuous grooves; the predetermined depth of the indentations can be from about 0.0002 inches to about 0.0010 inches. Preferably, the predetermined depth of the indentations is about 0.0005 inches.

According to another aspect of the invention, a machine for applying a texture to at least one of, individual plastic chips, tokens or gaming pieces, comprises at least one inlet hopper configured to accept and hold the at least one of, chips, tokens or gaming pieces having at least one upper planar surface and at least one lower planar surface, the inlet hopper dispensing the at least one of, chips, tokens or gaming pieces one at a time. At least one feeding mechanism can be configured to feed and move each of the at least one of, chip, token or gaming piece to a working position. At least one die can have a raised pattern, the die being movable to confront the at least one of, chip, token or gaming piece in the working position. A ram can be attached to the at least one die and is capable of moving the at least one die against the at least one of, chip, token or gaming piece to create at least one textured pattern corresponding to at least one textured pattern of the at least one die on at least one of the upper planar surface and at least one of the lower planar surface of the at least one of, chip, token or gaming piece.

According to yet other aspects of the invention, the inlet hopper can comprise a vibrating bowl feeder. The machine can further comprise a receiver configured to receive each of the at least one of, chip, token or gaming piece dispensed by the inlet hopper. The feeding mechanism can comprise a slide carriage actuated by a feed cylinder to move the at least one of, chip, token or gaming piece from the receiver to the working position. The feed cylinder can comprise a pneumatically actuated piston having a piston rod attached to the slide carriage. The at least one die can comprise an upper movable die carried by the ram for contacting the at least one upper planar surface of the at least one of, chip, token or gaming piece, and a lower stationary die for contacting the at least one lower planar surface of the at least one of, chip, token or gaming piece. The machine can further comprise at least one heater one of attached to or adjacent to the at least one die. The heater can maintain the temperature of the die from about 100 degrees Fahrenheit to about 200 degrees Fahrenheit; the heater can maintain the temperature of the die at about 150 degrees Fahrenheit. The heater can comprise an electric heater. The machine can further comprise a pneumatic cylinder for actuating the ram. The pneumatic cylinder can provide a force against the at least one die from about 2 tons to about 5 tons. The machine can further comprise a moving mechanism configured to move the at least one of, chip, token or gaming piece from the working position to an outlet hopper. The moving mechanism can comprise an air jet. The machine can further comprise a chute adjacent to the working position for guiding the at least one of, chip, token or gaming piece to the outlet hopper. The feed cylinder and the ram can be pneumatically actuated, and can further comprise a control panel for controlling air and electricity supplied to the machine. The machine can be configured to be portable from one location to another location. The machine can be configured to provide the least one textured pattern capable of disrupting surface tension between one of the at least one upper planar surface or the at least one lower planar surface of at least one of, a chip, token or gaming piece and another planar surface of another at least one of a chip, token or gaming piece.

According to a further aspect of the invention, a method is described, for resurfacing at least one of, chips, tokens, or gaming pieces having at least one upper planar surface and at least one lower planar surface by applying at least one textured pattern of indentations having a predetermined depth to at least one of the at least one upper planar surface and the at least one lower planar surface in order to reduce or prevent the at least one of, chips, tokens or gaming pieces from sticking to each other, the method comprising transporting each of the at least one of, chip, token or gaming piece to a working position; providing at least one die having a raised pattern; and pressing the at least one die against at least one of the at least one upper planar surface and the at least one lower planar surface to create the at least one textured pattern of indentations.

According to other aspects of the method according to the invention, the indentations can comprise grooves. The at least one textured pattern can disrupt surface tension between one of the at least one upper planar surface or the at least one lower planar surface of at least one of, a chip, token or gaming piece and another planar surface of another at least one of, chip, token or gaming piece; the indentations can cover an indentation area about 25% of one of a total area of the at least one upper planar surface and a total area of the at least one lower planar surface. Preferably, the indentation area is less than about 25% of one of a total area of the at least one upper planar surface and a total area of the at least one lower planar surface. More preferably, the indentation area is from about 2% to about 15% of one of a total area of the at least one upper planar surface and a total area of the at least one lower planar surface. Most preferably, the indentation area is from about 2% to about 5% of one of a total area of the at least one upper planar surface and a total area of the at least one lower planar surface. The predetermined depth of the indentations can be from about 0.0002 inches to about 0.0010 inches. More preferably, the predetermined depth of the indentations is about 0.0005 inches. The transporting of at least one of, chip, token or gaming piece to a working position can comprise placing each at least one of, chip, token or gaming piece in a receiver, and moving the at least one of, chip, token or gaming piece from the receiver to the working position; the transporting of each at least one of, chip, token or gaming piece to a working position can further comprise providing an inlet hopper for a plurality of at least one of, chips, tokens or gaming pieces, and dispensing the at least one of, chips, tokens or gaming pieces one at a time from the inlet hopper to the receiver. The at least one die can comprise an upper movable die and a lower stationary die, each having a raised pattern for applying the textured pattern to the at least one upper planar surface and the at least one lower planar surface, respectively, wherein the pressing comprises moving the upper movable die against the at least one upper planar surface of a at least one of, chip, token or gaming piece, and thereby pressing the lower planar surface of the at least one of, chip, token or gaming piece against the lower stationary die. The method can further comprise transporting the at least one of, chip, token or gaming piece to an outlet hopper, after the pressing of the at least one die against at least one of the at least one upper planar surface and the at least one lower planar surface. The method can further comprise providing an air jet adjacent to the working position, and wherein the transporting of the at least one of, chip, token or gaming piece to an outlet hopper comprises blowing the at least one of, chip, token or gaming piece from the working position into the outlet hopper using an air jet.

Other exemplary embodiments and advantages of the present invention can be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 is a perspective view of a chip having a textured surface according to one embodiment of the present invention.

FIG. 2 is a top view of a second pattern for the texture according to another embodiment of the present invention.

FIG. 3 is a top view of another embodiment of the present invention, showing a textured pattern.

FIG. 4 is a side diagrammatic view of the texturing machine according to one or more embodiments of the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

“Chips,” “tokens” or “gaming pieces” are used interchangeably herein and are defined as small, physical representations of certain values, such as a monetary value, that can be used in casinos or elsewhere.

A “textured pattern,” “pattern” or “texture” are used interchangeably herein and are defined as indentations to a surface, with a predetermined depth. Preferably, the surface prior to be indented, is smooth and planar. Although the textures are preferably in the form of a pattern, the “textured pattern,” “pattern” or “texture” are not necessarily required to have any more detailed pattern than is needed to carry out the objective of the present invention. In other words, the “textured pattern,” “pattern” or “texture” can merely have a predetermined depth of indentations that is necessary to carry out the objective of the present invention. However, the pattern is preferably in the form of grooves forming grids with exemplary shapes as further described. Unless specifically pointed out, the terms “grooves,” “indentations” or “depressions” are used interchangeably herein.

As defined herein, the term “about” is meant to encompass a range of values close to a specified number that is operable within the confines of the objectives of the present invention. Any range of number mentioned is meant to include individually a specific value or number within the range. For example, “from about 2% to about 15%” means that a specific individual value, such as 1.8%, 2%, 8%, 15%, 15.4% or other specific individual values or numbers can be represented on its own in this particular range that is still operable within the confines of the objectives of the present invention.

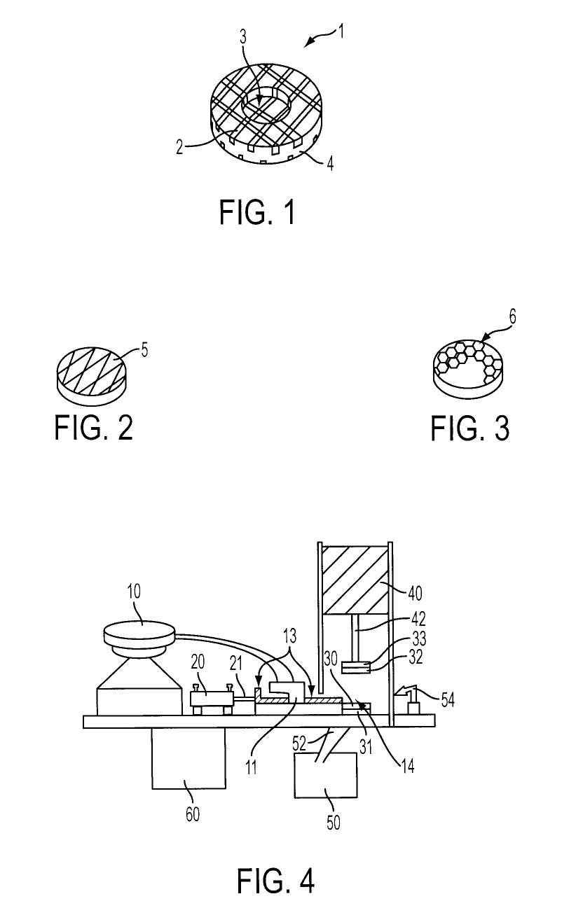

FIG. 1 shows an example of a textured chip 1 having a surface pattern formed by grooves or depressions 2. The chip shown in FIG. 1 includes a central round area 3 having a surface out of the plane of the remaining chip, where denomination labels can be placed. The grooves 2 extend across the chip through any central area and into the edge 4. Of course the invention can be embodied in chips without a central depressed area.

The depth, width, length and spacing of the grooves shown in FIG. 1 have been exaggerated for a clearer understanding. The dimensions of the grooves 2 can vary as long as the overall reduction of the upper or lower chip surface area caused by the width of the depressed grooves is preferably between about 2% and about 25%. In a preferred embodiment, the indentations or grooves cover an indentation area or groove area of about 25% of one of a total area of the at least one upper planar surface and a total area of the at least one lower planar surface. More preferably, the indentation area or groove area is less than about 25% of one of a total area of the at least one upper planar surface and a total area of the at least one lower planar surface. Even more preferably, the indentations or grooves cover an indentation area or groove area of from about 2% to about 15% of one of a total area of the at least one upper planar surface and a total area of the at least one lower planar surface. Most preferably, the indentations or grooves cover an indentation area or groove area of from about 2% to about 5% of one of a total area of the at least one upper planar surface and a total area of the at least one lower planar surface.

The predetermined depth of the indentations or grooves can be from about 0.0002 inches to about 0.0020 inches. Preferably, the indention depth or groove depth is about 0.0005 inches. A groove depth of 0.0010 inches has been found to yield acceptable results.

The chip can be a plastic body although other types of material can be incorporated into the chip, or the chip can wholly be made of a different material, such as, but not limited to, metal. For example, the chip can be embedded with at least one microchip that can be used to track the chips in a casino. As can be seen in FIG. 1, the chip has at least one upper planar surface and at least one lower planar surface. The chip can have more than one upper planar surface and more than one lower planar surface. Typically, the chip before it is modified according to the present invention, has planar surfaces that are generally smooth, or without indentations such as the grooves shown in the figures. The chip has at least one narrow peripheral edge surface extending between the at least one upper planar surface and the at least one lower planar surface. In the embodiment shown in FIG. 1 where the chip is round, the chip has one narrow peripheral edge surface. However, other shapes are possible, such as in the case where a chip has a square shape and therefore has four narrow peripheral edge surfaces.

As previously mentioned, the textured pattern on at least one of the at least one upper planar surface and at least one lower planar surface is defined by indentations having a predetermined depth and are sufficient in number and depth to reduce or prevent the at least one upper planar surface or the at least one lower planar surface from sticking together or adhering together to another planar surface of another chip. At least one textured pattern according to the present invention, provides the necessary disruption of the surface tension between planar surfaces of chips, thereby reducing or preventing the common problem of stickiness or adhesion that exists in the current used chips in the industry. The indentations are preferably grooves that traverse planar surface. More preferably, the indentations traverse the planar surface to the peripheral edge surface or peripheral edge surfaces if there is more than one. However, it is possible that the indentations do not traverse completely to the peripheral edge.

FIG. 1 shows grooves that are defined by three perpendicular surfaces in a cross-sectional view, other types of grooves and indentations being possible. For example, the grooves can be formed by two surfaces forming a “V” in a cross-sectional view.

The grooves can be at least one of continuous or discontinuous. In other words, the grooves can include segments of indentations, a continuous long groove extending completely to the narrow peripheral edge or edges, or a combination of both. Also, the indentations or grooves can extend across one of the at least one upper planar surface and the at least one lower planar surface in one of a straight line, a curved line, and a combination of straight and curved segments. Any combination of curved and straight lines or segments is possible as long as they provide the necessary surface tension disruption.

FIG. 1 shows the grooves arranged in a grid of rectangles defined by crossing grooves. Other alternative patterns for the texture are shown in FIGS. 2 through 4. In FIG. 2, the grooves 2 form a diamond grid pattern 5. In FIG. 3 the pattern is hexagonal 6. Thus, at least one textured pattern can include a grid formed by at least one of rectangles, squares, diamonds, hexagons, and any other shapes or combinations formed by intersections of continuous or discontinuous grooves and indentations. Whatever pattern is used, a clear line or opening to the outer edge 4 of the chip can at least ensure that the surface tension is broken and the chips do not stick.

The textured pattern can be applied during the original manufacture of the chip. The chip can be molded to the final thickness size or molded to an oversize, grinded to the final thickness and then textured to ensure a precise thickness. In this case, the dies used when molding the chip can include the appropriate pattern to impart the texture in the molten plastic. For those chips that have already been manufactured and in use, a machine can apply the texture in a post manufacturing process. Thus, according to other embodiments of the present invention, a machine for applying texture to individual chips, tokens or gaming pieces is provided.

FIG. 4 shows a texturing machine that can be utilized at a casino or other places that utilize chips, tokens or gaming pieces. Preferably, the machine is configured to be portable from one to another location.

According to one or more embodiments, the machine can include at least the following components: at least one inlet hopper configured to accept and hold the chips, tokens or gaming pieces having at least one upper planar surface and at least one lower planar surface, the inlet hopper dispensing the chips, tokens or gaming pieces one at a time, at least one feeding mechanism configured to feed and move each chip, token or gaming piece to a working position, at least one die having a raised pattern, the die being movable to confront the chip, token or gaming piece in the working position, and a ram attached to the at least one die and capable of moving the at least one die against the chip, token or gaming piece to create at least one textured pattern corresponding to at least one textured pattern of the at least one die on at least one of the upper planar surface and at least one of the lower planar surface of the chip, token or gaming piece.

As shown in FIG. 5, non-textured chips can be placed into an input hopper 10 to be transferred to a receiver 11 which will initiate the movement of each chip to a working position on the machine. The input hopper 10 illustrated in FIG. 5 is a vibratory bowl feeder. However, other feeding mechanisms can be configured and utilized to feed and move each chip, token or gaming piece to a working position. This feeder is capable of moving chips individually from the bowl 10 to the receiver 11, serially. The receiver stages each chip for movement by a slide carriage from its ready position, indicated generally by the reference number 13 in FIG. 5, to a working position indicated at 14. The bowl feeder can deliver the chips at the rate required for the operation. If some chips take a longer time in the press, the press can be configured to accept another chip only when it is ready to receive the chip and the bowl feeder then waits for another request. A chute can deliver the chip to a stacker device which then feeds the chips individually into position at the request of the press.

A reciprocating feed cylinder 20 actuates the slide carriage 13. The feed cylinder includes an internal piston whose piston rod 21 extends outwardly to connect to the slide carriage 12. The cylinder is actuated by air pressure (pneumatically), which is alternately introduced on opposite sides of the piston to effect a reciprocating movement. The cylinder can be of various sizes. For example, a 1 inch bore can deliver the chip with 30 psi air pressure and regulate the exhaust to provide a smooth delivery of the chip into the proper position.

Once moved by the slide carriage 13 to its working position 14, the chip can rest on a stationary lower die 30. The die 30 can include the predetermined raised pattern to be impressed on the lower surface of the chip. An upper die 32 can also include a raised pattern. The pattern raised on each die can be the same or different, as desired. Each die can be heated by an electric cartridge heater 31 and 33 associated with the lower and upper dies, respectively. Other mechanisms for heating the die and/or the chips are possible. Thus, one or more heaters may be used and the heaters can be attached to or be adjacent to the die or dies. The heated die is better able to penetrate the plastic surfaces of the chip. A temperature of about 150 degrees Fahrenheit has been found to produce acceptable penetration of the die. However, other temperatures can be used depending on the type of textured pattern desired, the type of material of the chips, etc., such as from about 100 degrees Fahrenheit to about 200 degrees Fahrenheit. Thus, the temperature used is dependent on the material used to make the chip and typically, 180 degrees Fahrenheit can be used for the majority of the chip materials. Although the preferred embodiment includes two dies, different number of dies can be used, such as one, three, four, etc.

The necessary die force can be provided by a pneumatic cylinder 40 that moves a ram 42 on whose lower end the upper heater 33 and die 32 are attached. Preferably, the ram is capable of providing from about 2 tons to about 5 tons of force to the die. However, other types of devices that provide the necessary force can be used. The amount of force utilized can vary depending on the type of textured pattern desired and the type of material of the chips, among other factors. Thus, the pressure used varies with the material used to make the chip and the desired design of the texture, and typically, 3.5 tons of pressure can be used.

After the ram has caused the dies to impress the textured pattern onto the chip, the ram can be lifted and the chip can be moved from the working position to an output or outlet hopper 50. The hopper can be filled with chips from a chute 52 that extends from the working position 14, thereby guiding the chip to an outlet hopper. A particularly convenient element to move the chip from atop the lower die to the chute 52 is an air jet 54, which emits a stream of air across the chip at the appropriate moment to blow it to the chute 52 and into the outlet hopper 50. However, other mechanisms of moving the chip can be utilized, such as another piston.

In this pneumatically operated machine, suitable control elements, such as control valves can be utilized to control and sequence the application of air pressure to the feed cylinder 20, the pneumatic ram cylinder 40 and the air jet 54. Additionally, a computer and the appropriate software can be utilized to control electronically any of the components of the machine, thereby automating the process of texturizing the chips. For example, with these controls, up to 2000 chips per hour can be textured. A control panel 60 can be equipped with the necessary electronics and software to sequence the valves or other components (controlling the air and electricity supplied to the machine for example) of the machine as well as to establish the timing and the time intervals of the various movements. The control panel can also include controls for adjusting the heating of the dies.

For example, the valves that are used can be four-way solenoid actuated. The solenoids can be actuated by a signal from timers or a PLC control to sequence the cylinders in the proper order to accomplish the process steps needed. The timers can be adjustable to accommodate varying size chips and texture designs.

Although the texture machine described above utilizes air as the motive fluid, hydraulics can also be used. Also although the ram is described as being air actuated, electrically driven mechanical drives can also be utilized in conjunction or in lieu of the air actuation. Furthermore, various input devices or inlet hoppers can be used as alternatives to the vibratory bowl feeder 10, as well as output devices or outlet hoppers. A simple frame for holding a stack of chips above the receiver can yield acceptable performance. Thus, the texture machine according to the present invention can be configured to provide the least one textured pattern capable of disrupting surface tension between one of the at least one upper planar surface or the at least one lower planar surface of a chip, token or gaming piece and another planar surface of another chip, token or gaming piece.

Thus, according to various embodiments, the present invention overcomes the tendency of chips, tokens or gaming pieces from sticking together by providing texture on the planar surfaces of the chips, tokens or gaming pieces. Various benefits are provided such as allowing better handling, movability and tracking the chips, tokens or gaming pieces.

It is noted that the foregoing examples have been provided merely for the purpose of explanation and are in no way to be construed as limiting of the present invention. While the present invention has been described with reference to exemplary embodiments, it is understood that the words that have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A chip, token or gaming piece comprising:
a plastic body having at least one upper planar surface and at least one lower planar surface;
at least one narrow peripheral edge surface extending between the at least one upper planar surface and the at least one lower planar surfaces;
at least one textured pattern on at least one of the at least one upper planar surface and the least one lower planar surface, the at least one textured pattern being defined by indentations that traverse at least one of the at least one upper planar surface and the at least one lower planar surface; and
the indentations having a predetermined depth and being sufficient in number and depth to reduce or prevent one of the at least one upper planar surface and the at least one lower planar surface from sticking or adhering to another planar surface of another chip, token or gaming piece.

2. The chip, token or gaming piece of claim 1, wherein the indentations comprise grooves.

3. The chip, token or gaming piece of claim 2, wherein the grooves are one of continuous and discontinuous.

4. The chip, token or gaming piece of claim 1, wherein the indentations extend to the at least one narrow peripheral edge surface.

5. The chip, token or gaming piece of claim 1, further comprising at least one embedded microchip.

6. The chip, token or gaming piece of claim 1, wherein the at least one textured pattern disrupts surface tension between one of the at least one upper planar surface or the at least one lower planar surface of a chip, token or gaming piece and another planar surface of another chip, token or gaming piece.

7. The chip, token or gaming piece of claim 1, wherein the indentations extend across one of the at least one upper planar surface and the at least one lower planar surface in one of a straight line, a curved line, and a combination of straight and curved segments.

8. The chip, token or gaming piece as in claim 1, wherein the indentations cover an indentation area of about 25% of one of a total area of the at least one upper planar surface and a total area of the at least one lower planar surface.

9. The chip, token or gaming piece of claim 8, wherein the indentation area is less than about 25% of one of a total area of the at least one upper planar surface and a total area of the at least one lower planar surface.

10. The chip, token or gaming piece of claim 9, wherein the indentation area is from about 2% to about 15% of one of a total area of the at least one upper planar surface and a total area of the at least one lower planar surface.

11. The chip, token or gaming piece of claim 9, wherein the indentation area is from about 2% to about 5% of one of a total area of the at least one upper planar surface and a total area of the at least one lower planar surface.

12. The chip, token or gaming piece of claim 2, wherein the at least one textured pattern comprises a grid formed by at least one of rectangles, squares, diamonds, hexagons, and other shapes formed by intersections of continuous grooves.

13. The chip, token or gaming piece of claim 1, wherein the predetermined depth of the indentations is from about 0.0005 inches to about 0.0020 inches.

14. The chip, token or gaming piece of claim 13, wherein the predetermined depth of the indentations is about 0.0010 inches.

15. A machine for applying a texture to at least one of, individual plastic chips, tokens or gaming pieces, comprising:
at least one inlet hopper configured to accept and hold the at least one of, chips, tokens or gaming pieces having at least one upper planar surface and at least one lower planar surface, the inlet hopper dispensing the at least one of, chips, tokens or gaming pieces one at a time;
at least one feeding mechanism configured to feed and move each of the at least one of, chip, token or gaming piece to a working position;
at least one die having a raised pattern, the die being movable to confront the at least one of, chip, token or gaming piece in the working position; and
a ram attached to the at least one die and capable of moving the at least one die against the at least one of, chip, token or gaming piece to create at least one textured pattern corresponding to at least one textured pattern of the at least one die on at least one of the upper planar surface and at least one of the lower planar surface of the at least one of, chip, token or gaming piece.

16. The machine of claim 15, wherein the inlet hopper comprises a vibrating bowl feeder.

17. The machine of claim 15, further comprising a receiver configured to receive each of the at least one of, chip, token or gaming piece dispensed by the inlet hopper,
the feeding mechanism comprising a slide carriage actuated by a feed cylinder to move the at least one of, chip, token or gaming piece from the receiver to the working position.

18. The machine of claim 17, wherein the feed cylinder comprises a pneumatically actuated piston having a piston rod attached to the slide carriage.

19. The machine of claim 15, wherein the at least one die comprises an upper movable die carried by the ram for contacting the at least one upper planar surface of the at least one of, chip, token or gaming piece, and a lower stationary die for contacting the at least one lower planar surface of the at least one of, chip, token or gaming piece.

20. The machine of claim 15, further comprising at least one heater one of attached to or adjacent to the at least one die.

21. The machine of claim 20, wherein the heater maintains the temperature of the die from about 100 degrees Fahrenheit to about 200 degrees Fahrenheit.

22. The machine of claim 21, wherein the heater maintains the temperature of the die at about 150 degrees Fahrenheit.

23. The machine of claim 20, wherein the heater comprises an electric heater.

24. The machine of claim 15, further comprising a pneumatic cylinder for actuating the ram.

25. The machine of claim 24, wherein the pneumatic cylinder provides a force against the at least one die from about 2 tons to about 5 tons.

26. The machine of claim 15, further comprising a moving mechanism configured to move the at least one of, chip, token or gaming piece from the working position to an outlet hopper.

27. The machine of claim 26, wherein the moving mechanism comprises an air jet.

28. The machine of claim 27, further comprising a chute adjacent to the working position for guiding the at least one of, chip, token or gaming piece to the outlet hopper.

29. The machine of claim 17, wherein the feed cylinder and the ram are pneumatically actuated, and further comprising a control panel for controlling air and electricity supplied to the machine.

30. The machine of claim 15, wherein the machine is configured to be portable from one location to another location.

31. The machine of claim 15, wherein the machine is configured to provide the least one textured pattern capable of disrupting surface tension between one of the at least one upper planar surface or the at least one lower planar surface of at least one of, a chip, token or gaming piece and another planar surface of another at least one of a chip, token or gaming piece.

32. A method for resurfacing at least one of, chips, tokens, or gaming pieces having at least one upper planar surface and at least one lower planar surface by applying at least one textured pattern of indentations having a predetermined depth to at least one of the at least one upper planar surface and the at least one lower planar surface in order to reduce or prevent the at least one of, chips, tokens or gaming pieces from sticking to each other, the method comprising:
transporting each of the at least one of, chip, token or gaming piece to a working position;
providing at least one die having a raised pattern; and
pressing the at least one die against at least one of the at least one upper planar surface and the at least one lower planar surface to create the at least one textured pattern of indentations.

33. The method of claim 32, wherein the indentations comprise grooves.

34. The method of claim 32, wherein the at least one textured pattern disrupts surface tension between one of the at least one upper planar surface or the at least one lower planar surface of at least one of, a chip, token or gaming piece and another planar surface of another at least one of, chip, token or gaming piece.

35. The method of claim 32, wherein the indentations cover an indentation area about 25% of one of a total area of the at least one upper planar surface and a total area of the at least one lower planar surface.

36. The method of claim 35, wherein the indentation area is less than about 25% of one of a total area of the at least one upper planar surface and a total area of the at least one lower planar surface.

37. The method of claim 36, wherein the indentation area is from about 2% to about 15% of one of a total area of the at least one upper planar surface and a total area of the at least one lower planar surface.

38. The method of claim 36, wherein the indentation area is from about 2% to about 5% of one of a total area of the at least one upper planar surface and a total area of the at least one lower planar surface.

39. The method of claim 32, wherein the predetermined depth of the indentations is from about 0.0005 inches to about 0.0020 inches.

40. The method of claim 39, wherein the predetermined depth of the indentations is about 0.0010 inches.

41. The method of claim 32, wherein the transporting of at least one of, chip, token or gaming piece to a working position comprises placing each at least one of, chip, token or gaming piece in a receiver, and moving the at least one of, chip, token or gaming piece from the receiver to the working position.

42. The method of claim 41, wherein the transporting of each at least one of, chip, token or gaming piece to a working position further comprises providing an inlet hopper for a plurality of at least one of, chips, tokens or gaming pieces, and dispensing the at least one of, chips, tokens or gaming pieces one at a time from the inlet hopper to the receiver.

43. The method of claim 32, wherein the at least one die comprises an upper movable die and a lower stationary die, each having a raised pattern for applying the textured pattern to the at least one upper planar surface and the at least one lower planar surface, respectively, and wherein the pressing comprises moving the upper movable die against the at least one upper planar surface of a at least one of, chip, token or gaming piece, and thereby pressing the lower planar surface of the at least one of, chip, token or gaming piece against the lower stationary die.

44. The method of claim 32, further comprising transporting the at least one of, chip, token or gaming piece to an outlet hopper, after the pressing of the at least one die against at least one of the at least one upper planar surface and the at least one lower planar surface.

45. The method of claim 44, further comprising providing an air jet adjacent to the working position, and wherein the transporting of the at least one of, chip, token or gaming piece to an outlet hopper comprises blowing the at least one of, chip, token or gaming piece from the working position into the outlet hopper using an air jet.
